(19) United States
(12) Patent Application Publication
(10) Pub. No.: US 2024/0165705 A1
(43) Pub. Date: May 23, 2024

(54) SINTERED TITANIUM COMPONENTS AND ADDITIVE MANUFACTURING METHODS THEREOF

(71) Applicant: University of Utah Research Foundation, Salt Lake City, UT (US)

(72) Inventors: Pei Sun, Salt Lake City, UT (US); Nathan Jump, Salt Lake City, UT (US); Madapusi Kande Keshavan, Salt Lake City, UT (US); Zhigang Zak Fang, Salt Lake City, UT (US)

(21) Appl. No.: 18/518,857

(22) Filed: Nov. 24, 2023

Related U.S. Application Data
(60) Provisional application No. 63/427,706, filed on Nov. 23, 2022.

(51) Int. Cl. B22F 10/14; B22F 3/10

(52) U.S. Cl. CPC B22F 10/14; B22F 3/1007; B22F 3/1021; B22F 2201/013; B22F 2301/205; B22F 2304/10

(57) ABSTRACT

A method of making a densified sintered titanium article includes forming a powder bed of a titanium feedstock. A binder is applied to a portion of the powder bed to bind the titanium feedstock together, thereby forming a green body. The green body is debinded to remove at least a portion of the binder to form a debinded titanium article. The debinded titanium article is sintered at a sintering temperature in an atmosphere comprising hydrogen to produce a sintered titanium article. The sintered titanium article is held at a phase transition temperature to form a microstructure-controlled titanium article. The microstructure-controlled titanium article is dehydrogenated to form a densified sintered titanium article.

### CROSS REFERENCE TO RELATED APPLICATIONS

This application claims priority to U.S. Provisional Application No. 63/427,706, filed Nov. 23, 2022, which is incorporated herein by reference.

### GOVERNMENT INTEREST

None.

### BACKGROUND

Titanium alloys have high specific strength, excellent corrosion resistance, and great biocompatibility. Due to these properties, titanium alloys may have profound implications for sustainability if made economical for widespread commercial utilization. Wider use of these materials can significantly improve energy efficiency in many applications such as the automotive, aerospace, defense, medical, oil and gas and many other industries reducing the weight of high-strength components. Making these components from titanium materials can also provide significantly increased service life. However, the traditional processes for making high-performance titanium materials, such as wrought processing, are highly energy-intensive, making these materials unfeasible for most commercial applications outside of aerospace and biomedicine. Furthermore, the mill products produced by wrought processing can only be made in simple geometries, such as plate, sheet, and bar stock. Therefore, producing end-user components typically requires extensive machining, forming, joining, etc., which further increase the embodied energy by increasing the amount of energy required for production and limiting overall yield through material loss

Near-net-shape production technologies, such as additive manufacturing (AM) have been identified as a means to significantly improve the economics of using titanium alloys for a wide variety of applications. Such processes avoid the energy-intensive thermomechanical processing employed by wrought processing. Additionally, these technologies can directly produce complex geometries, which allows for significant reduction in the amount of subsequent machining, forming, joining, etc., required. Current AM methods used in the manufacture of Ti alloys are laser bed fusion and electron beam process. These processes produce near net sintered products.

### SUMMARY

A method of making a densified sintered titanium article can include forming a green body using an additive manufacturing (i.e., 3D printing) process followed by a sintering, phase transformation, and dehydrogenation process. In particular, the green body can be formed by depositing a powder bed of a titanium feedstock and applying a binder to a portion of the powder bed to bind the titanium feedstock together. The green body can be debinded to remove at least a portion of the binder to form a debinded titanium article. The debinded titanium article can be sintered at a sintering temperature in an atmosphere that includes hydrogen. This sintering can produce a sintered titanium article. The sintered titanium article can be held at a phase transformation temperature to form a microstructure-controlled titanium article. The microstructure-controlled titanium article can be dehydrogenated to form a densified sintered titanium article.

The present disclosure also describes titanium materials formed using the methods described herein. In some examples, the titanium materials can have a small grain size, high densification, high tensile strength, low oxygen and carbon contents, among other useful properties. Because the materials can be formed using an additive manufacturing process, the materials can be made in a wide variety of shapes achievable using additive manufacturing.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a flowchart of an example method of making densified sintered titanium articles in accordance with the present disclosure.

FIGS. 2A-2D illustrate a method of additive manufacturing used in methods of making densified sintered titanium articles in accordance with the present disclosure.

FIG. 3 is a graph of temperature over time for an argon sintering process.

FIG. 4 is a graph of temperature over time for a hydrogen sintering and phase transformation (HSPT) process.

FIG. 5 is a phase diagram illustrating a vacuum sintering process and a HSPT process used in connection with examples of the present disclosure.

FIG. 6 is a scanning electron micrograph showing the microstructure of a comparative argon sintered titanium material.

FIG. 7 is a scanning electron micrograph showing the microstructure of a titanium material made using a method according to the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

As used herein, “fine and ultrafine” refer to grain sizes which range from about 5 μm to about 20 μm for fine grains, and less than 1 μm to about 5 μm for ultrafine grains. Most often grains sizes can be about 0.1 μm to about 3 μm.

As used herein, the terms “dynamically controlled hydrogen atmosphere” or “dynamically controlled H₂ partial pressure” are used to mean that the H₂ partial pressure can be held constant or varied as a function of time during each step in the thermal cycle. In any embodiment, H₂ partial pressure is dynamically controlled during sintering and phase transformations including eutectoid decomposition as a function of time and temperature in order to precisely control the microstructure of the as-sintered Ti or Ti alloy. The H₂ partial pressure is controlled by the addition or removal of H₂ from the atmosphere using mass flow controllers or pressure controllers. When hydrogenated titanium is used as all or part of the particulate feedstock material, H₂ will be naturally evolved during heating of the material. However, in some examples of the methods described herein, the level of hydrogen can be dynamically controlled beyond this natural occurrence by the addition or removal of additional H₂ gas. The partial pressure of hydrogen during sintering at the elevated temperatures can be greater than 0.01 atmosphere, and in some cases greater than 0.1 atmosphere. The degree of grain refinement due to phase transformations including eutectoid decomposition and dehydrogenation results from the changing phase equilibria between α, α₂, β, and δ phases of Ti and Ti alloys during processing. These phase equilibria change with temperature and with equilibrium hydrogen concentration, which varies as a function of temperature and H₂ partial pressure. Therefore, by dynamically controlling partial pressure of H₂ as well as temperature, phase evolution and, therefore, microstructure can be precisely controlled at each step of the process. The dynamically controlled hydrogen atmosphere can have partial pressures of H₂ between 0.01 atm and 10 atm, which are achieved by a mixture of H₂ and an inert gas at approximately 1 atm to 10 atm total pressure, pure H₂ at pressures approximately between 0.01 atm and 10 atm, or a fixed mixture of H₂ and inert gas at pressures between 0.01 and 20 atm. Therefore, partial pressure of H₂ is dynamically controlled by dynamically varying the gas ratio in the former example, or the absolute system pressure in the latter two. The partial pressure of H₂ can be controlled independently of any H₂ that is produced from the evolution of H₂ gas from hydrogenated titanium during sintering. Different H₂ partial pressure profiles can be used to tailor the mechanical properties of the as-sintered material by controlling the as-sintered microstructure.

As used herein, the term “near full density” refers to a minimization of porosity in the material, such that if full density were achieved, the density of the bulk material would be equal to that of the theoretical density of the material. As used herein, near full density refers to the material having a relative density of greater than 98%. As used herein, and as eluded to above, full density refers to the material having a relative density of greater than 99%. According to some embodiments, the densified sintered titanium material made using the methods described herein has a relative density greater than 97%. In other embodiments, the titanium material has a near full density. In other embodiments, the titanium material has a full density.

As used herein, the term α-phase refers to a hexagonal close-packed (HCP) solid solution of Ti with alloying elements. The α-phase may or may not contain some hydrogen. The term β-phase refers to a body-centered cubic (BCC) Ti solid solution with alloying elements, which may or may not also contain hydrogen. The term δ-phase refers to a face-centered cubic (FCC) hydrogenated titanium or Ti hydride, TiHₓ, where x varies from 1.5 to 2, at room temperature. The term α₂ refers to Ti₃Al phase which is an ordered hexagonal structure with DO19 crystal structure. The definitions of the phases are further illustrated by the phase diagrams of Ti—H (ASM Handbook, Vol. 3, p. 238, 1992), and Ti-6Al-4V-H. It should be noted that the phase diagrams of titanium alloys with hydrogen vary considerably within the scientific literature and are not yet completely characterized. Therefore, the exact temperatures and time of sintering, isothermal holding for phase transformations, and dehydrogenation will all vary accordingly.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

The use of the terms “a” and “an” and “the” and similar referents in the context of describing the elements (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Additionally, the phrase “consisting essentially of” will be understood to include those elements specifically recited and those additional elements that do not materially affect the basic and novel characteristics of the claimed invention. The phrase “consisting of” excludes any element not specifically specified.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein.

Accordingly, the scope of the invention should be determined solely by the appended claims and their legal equivalents, rather than by the descriptions and examples given herein.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Methods of Making Densified Sintered Titanium Articles

A process is provided for making densified sintered titanium articles using additive manufacturing and sintering. The additive manufacturing process can include forming a green body by applying a binder to a powder bed of a titanium feedstock. The green body can then be sintered to form a sintered titanium article. The methods described herein can produce titanium and titanium alloys with near-full and full density and fine or ultrafine grain sizes in an as-sintered state without, or with minimal, post-sintering processing. The ultrafine grain and near-porosity-free microstructure of the resulting material allows for flexibility in custom engineering of the microstructure of titanium materials. The near porosity-free ultrafine microstructure is achieved by sintering under a dynamically controlled hydrogen atmosphere with a partial pressure of H₂ greater than 0.01 atm at high temperatures (>1000° C.) during sintering densification, followed by subjecting the material to phase transformations and dehydrogenation at moderate temperatures (400-1000° C.). The dynamically controlled hydrogen pressure is selected based on considerations of the equilibrium pressure as a function of the temperature and desired final microstructure which can be affected by the hydrogen content in the titanium or titanium alloy. The thermal cycle is designed such that the phase transformations during the eutectoid transformation and dehydrogenation are controlled so that they lead to ultrafine microstructure features without significant grain growth. Through the present process, powder compacts of titanium metal, hydrogenated titanium or Ti hydride, with or without alloying elements (e.g. Ti-6Al-4V), can be sintered to full density (>99% relative density) with grain sizes under 10 micrometers (μm).

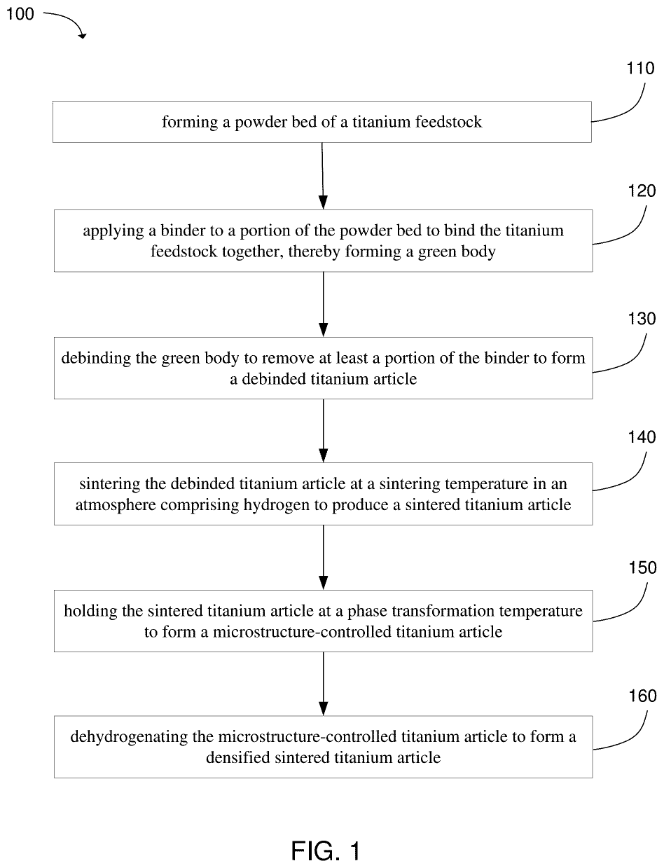

As illustrated in FIG. 1, an example method 100 of making a densified sintered titanium article can include the following steps: forming a powder bed of a titanium feedstock 110; applying a binder to a portion of the powder bed to bind the titanium feedstock together, thereby forming a green body 120; debinding the green body to remove at least a portion of the binder to form a debinded titanium article 130; sintering the debinded titanium article at a sintering temperature in an atmosphere comprising hydrogen to produce a sintered titanium article 140; holding the sintered titanium article at a phase transformation temperature to form a microstructure-controlled titanium article 150; and dehydrogenating the microstructure-controlled titanium article to form a densified sintered titanium article 160.

Additive manufacturing processes have been used to make metal articles from metal powders, such as titanium and titanium alloy powders. However, many previous processes for making such titanium articles result in material properties that are inferior to the properties of machined and wrought titanium products. For example, laser bed fusion in inert gases and electron beam melting in vacuum processes can form titanium articles by fusing titanium powder in situ. These processes are energy intensive and expensive compared to binder jetting processes. Binder jetting processes have any been used for making titanium green bodies, followed by sintering in vacuum or inert gases to make sintered titanium articles. However, the properties of machined or wrought titanium products are not achieved by these processes. The present disclosure describes methods that can be used to achieve similar properties to machined and wrought titanium products while maintaining the capabilities provided by additive manufacturing. The methods involve applying a binder to a powder bed of titanium feedstock powder to form a green body by additive manufacturing, followed by various heating steps to form a densified sintered titanium article. The methods provide ways to control oxygen content, porosity, and microstructure of the titanium article.

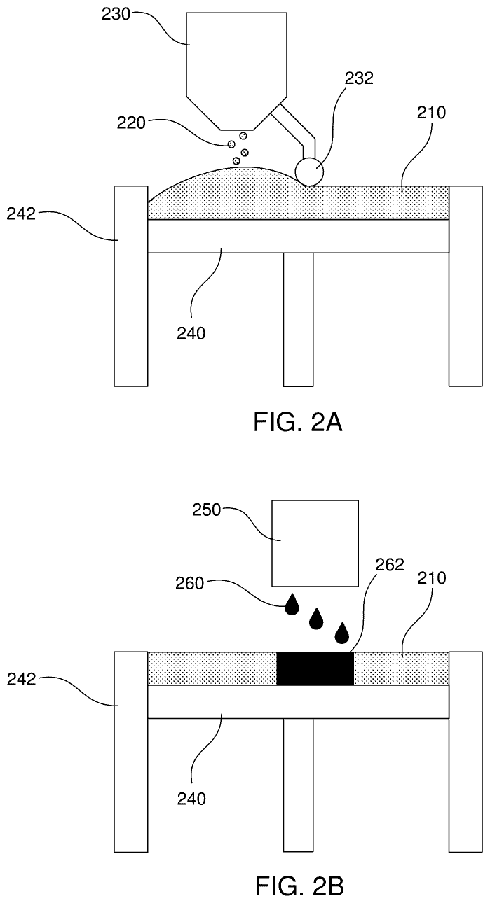

FIGS. 2A-2D illustrate an additive manufacturing process that can be used in the methods described herein. As shown in FIG. 2A, a powder bed 210 is formed by depositing particles 220 of a titanium feedstock. In this example, the titanium feedstock is deposited by a powder source 230 and then a roller 232 is used to level the top of the layer of titanium feedstock powder. The powder bed is supported by a build platform 240 and the powder is contained on the sides by sidewalls 242. After a flat layer of titanium feedstock powder is deposited, a binder 260 is selectively applied to portions of the powder bed as shown in FIG. 2B. In this example, the binder is applied by a binder jet 250. The binder binds together titanium feedstock particles in the portion of the powder bed where the binder was applied. This forms a slice 262 of the green body that is being printed. The titanium feedstock in areas of the powder bed where the binder was not printed remains as loose powder. In some cases, the loose titanium feedstock powder can be recycled and used for subsequent additive manufacturing. In FIG. 2C, the build platform is lowered to make space for additional titanium feedstock powder. Another layer of titanium feedstock powder is deposited and leveled. Then, in FIG. 2D, the binder is again applied to a portion of the powder bed, forming an additional slice of the green body. This process can be repeated many times to add more slices to the green body until a finished shape is achieved.

After the green body has been formed by additive manufacturing, the green body can be subjected to treatments such as debinding, sintering, phase transformation, deoxygenation, and dehydrogenation. In some examples, the debinded green body can be sintered using the hydrogen sintering and phase transformation (HSPT) process, which is described in more detail below.

The titanium feedstock can be a particulate titanium material provided in powder form. For example, Ti powder, TiH₂ powder, Ti alloy powder and hydrogenated Ti alloy powder are commercially available. The particulate titanium feed material can be sintered together with alloying additives. These alloying additives can also be provided in powder form. Suitable alloying additives can include aluminum, carbon, chromium, cobalt, copper, gallium, germanium, iron, manganese, molybdenum, nickel, niobium, nitrogen, oxygen, palladium, ruthenium, silicon, tantalum, tin, vanadium, zirconium, hafnium, group 4 elements, group 5 elements, oxides thereof, and mixtures or alloys thereof, such as the commercially available 60Al-40V alloy. Particulate titanium feed materials and alloying additives can be mixed together in ratios corresponding to a desired alloy composition for the final sintered material. For example, in some embodiments the mixture can have the composition of Ti-6Al-4V alloy.

The titanium feedstock can consist of particulate titanium and/or hydrogenated titanium that has or has not been previously alloyed with the desired elements for the alloy (e.g. aluminum and vanadium for Ti-6Al-4V) as well as particulate alloying elements that are in the form of individual powders or pre-alloyed “master alloys” (e.g. 60Al/40V master alloy for Ti-6Al-4V). The particulate titanium and alloying element feed materials may be provided in commercially available powders that are produced from virgin metal using any of the extractive process used in commercial titanium production including, but not limited to, the Kroll Process, the Armstrong Process, the Hunter Process, etc. The particulate titanium and alloying element feed materials may come from materials that are traditionally considered by-products of commercial titanium production processes, such as “sponge fines” from the Kroll Process. The particulate titanium and alloying element feed materials may come from scrap that is produced during milling, machining, or recycling of metals. The particulate titanium and alloying element feed materials may come from a combination of the aforementioned sources. In one embodiment, the particulate titanium and alloying element feed materials can be produced by hydrogenating Ti-6Al-4V machine turning and ball milling to an appropriate size and morphology for compaction and sintering. HDH powder produced using titanium Kroll sponge or scrap of titanium (including titanium alloys) by the hydrogenation-dehydrogenation (HDH) process can also be used as source material in the binder jet process.

The powders of titanium feed material and the alloying additives can have a variety of particle sizes. In one embodiment, the powder can have a size from about −20 mesh to about −1200 mesh (or <841 to <12 micrometers). In another embodiment, the powder can have a size of from about −100 mesh to about −325 mesh (or <149 to <44 micrometers). In another embodiment, the powder can have a size of about −200 mesh to about −325 mesh (or <74 to <44 micrometers). In another embodiment, the powder can have a size of about −400 mesh. In another embodiment, the powder can have a size of from about −325 mesh to about −450 mesh (or <44 to <32 micrometers), and in another case to about −400 mesh. In another embodiment, the powder can have a size of from about −325 mesh to about −635 mesh (or <44 to <20 micrometers). In another embodiment, the powder can have a size of from about −325 mesh to about −1200 mesh (or <44 to <10 micrometers). In another embodiment, the powder can have a size of from about −450 mesh to about −635 mesh (or <32 to <20 micrometers). In another embodiment, the powder can have a size of from about −400 mesh to about −1200 mesh (or <37 to <10 micrometers). In one optional embodiment, the particulate titanium feed material can be prepared by combining corresponding powders with average particle sizes greater than 20 μm with a non-volatile liquid to form a slurry. The slurry mixture can be subjected to size reduction processing (e.g. mechanical or other techniques) to produce powders with average particle sizes less than 20 μm, such as submicron to 20 μm. After the size reduction processing, the slurry can be dried or drained to remove excess liquid and powder particles of which the surface is coated by the non-volatile liquid and isolated from surrounding air or other gaseous atmosphere are collected.

In some embodiments of the present process, coarse powders of titanium feed material and alloying additives can be used. Usually, the coarser the initial powder, the lower the final oxygen content of the material. When using traditional powder metallurgy methods to make titanium components from titanium metal powders, coarse powders tend to be very difficult to consolidate, and also lead to coarse final microstructure with detrimental levels of residual porosity. In contrast, fine Ti metal powders are prone to oxygen contamination. In some examples, coarse TiH₂ powder can be used as the starting raw material, thereby making it easier to control oxygen content in the subsequent powder pressing, forming, sintering, and dehydrogenation steps, while coarse TiH₂ powder poses few difficulties in densification to near full density provided that proper powder processing and compaction techniques are used. The use of finer powders may still result in relatively lower porosity levels, smaller pores, and higher density, and may be used in the stated process. The use of coarse powders in the present process does not lead to coarse final grain microstructure because of the controlled stages of densification during sintering and phase transformation. The grain size of the final material is not strongly affected by the initial particle size of the powder because the grain size is primarily a function of the temperature versus time profiles and partial pressure of H₂ versus time profiles of the sintering, phase transformations including eutectoid decomposition, and dehydrogenation steps. Therefore, the present process can produce strong sintered titanium materials with lower oxygen content at a lower cost than traditional powder metallurgy approaches.

It can also be useful to use a titanium feedstock that has a low initial oxygen content and high purity in order to make a final densified sintered titanium article having low oxygen and high purity. In some examples, the titanium feedstock can have an oxygen content of less than 0.2% by weight. In further examples, the titanium feedstock can have an oxygen content of less than 0.1% by weight. The titanium feedstock can also be free of other impurities or have low concentrations of other impurities. In a particular example, the titanium feedstock can be free of silicon or contain silicon in an amount less than 0.1% by weight. Besides oxygen, silicon, and small amounts of other impurities, the titanium feedstock can include titanium, optionally alloying metal, and optionally hydrogen.

In order to reduce residual porosity to desirable lower levels and minimize the size of the residual pores in produced materials, a finer starting powder size may be desirable, while retaining the desired lower oxygen levels (i.e. less than 0.2% and in some cases less than 0.1% by weight). In one embodiment, powders of hydrogenated titanium or Ti hydride, possibly with titanium and other alloying elements, can be milled to finer sizes with a protective coating of a non-volatile liquid. Suitable non-volatile liquid can substantially coat the powders to prevent oxidizing during milling. This non-volatile liquid can be an organic liquid such as a natural or synthetic oil such as mineral oils, an ionic liquid, or a mixture of these liquids. In this procedure, the powders are mixed with a selected non-volatile liquid between 1/20^{th} and 20 times the volume of the powder, and then subjected to a particle size reduction process. For example, the powder can be milled in any of a range of milling devices, including but not limited to: drum mills, roller mills, ball mills, hammer mills, vibration mills, jet mills, attritor mills, or planetary mills. The powder and liquid mixture may or may not be under a protective cover gas of argon or other inert gas. The milled powder slurry can be dried or drained to remove excess liquid. Powder particles of which the surfaces are coated by the non-volatile liquid and isolated from the air or other gaseous atmosphere can then be collected for subsequent processing.

In various examples, the titanium feedstock can have an average particle size from 10 μm to 100 μm. In further examples, the titanium feedstock can have an average particle size from 15 μm to 50 μm or from 20 μm to 30 μm. In some examples, these particles can be agglomerated particles, made up of smaller primary particles. The primary particles can have an average particle size from less than 1 μm to a few μm, such as from about 0.1 μm to about 5 μm. In certain examples, the titanium feedstock can have a bimodal size distribution, meaning two different peak average particle sizes mixed together. For example, the titanium feedstock can include about 10% by weight of smaller size particles and about 90% by weight of larger size particles. In other examples, the amount of smaller size particles can be from about 5% to about 30%, or from about 10% to about 20% by weight, and the amount of larger size particles can be from about 70% to about 95%, or from about 80% to about 90% by weight.

In certain examples, the titanium feedstock can be particles prepared using the granulation-sintering-deoxygenation process (GSD). As used herein, GSD refers to a process of making agglomerated particles with a substantially spherical shape. In the GSD process, a particulate source material, such as titanium, titanium hydride, or other feedstock materials described herein, can be mixed with a binder in a solvent to form a slurry. The primary particles of the particulate source can optionally be ball milled to a smaller particle size. The slurry can then be granulated to form substantially spherical granules. The individual granules can be agglomerations of the primary particles held together by the binder. These granules can then be debinded at a debinding temperature to reduce the binder content of the granules, forming debinded granules. The debinded granules can be partially sintered or fully sintered at a sintering temperature such that particles within each granule fuse together to form partially or fully sintered granules. Depending on specific powder packing techniques and the sintering temperature, the sintered granules can be discrete particles, or the sintered granules can be connected to each other forming a frangible body of partially or fully sintered granules. The sintered granules can then be recovered to form the substantially spherical metal powder. In some cases, separation of the granules can involve breaking the frangible body, while in many cases discrete sintered granules can be removed from the furnace.

In the GSD process, the starting particle size of the particulate source metal can generally be smaller than the final particle size of the substantially spherical particles that are to be used as the titanium feedstock in the additive manufacturing methods described herein. In some cases, the average starting particle size can be less than about 10 micrometers. For example, the average starting particle size can be from about 1 micrometer to about 10 micrometers. Alternatively, the average starting particle size can be from about 0.01 micrometers to about 1 micrometer. As the particulate source metal can often have irregularly-shaped particles, the starting particle size can be the length of the longest dimension of the particles.

In some examples, the starting particle size can be greater than 30 micrometers, or greater than +325 mesh. These relatively coarse powders can be reduced in size by milling in order to make spherical granules that are less than 30 micrometers in size. For making spherical granules with sizes greater than 30 micrometers, or greater than 50 micrometers, ball milling may not be necessary. In further examples, the starting particle size can be 1-10 micrometers or less than 5 micrometers, which may be achieved by milling or other techniques for particle size reduction.

The GSD process can involve mixing the particulate source material with a binder and a solvent to form a slurry. In some embodiments, mixing the particulate source metal with the binder can comprise wet milling the particulate source metal and the polymeric binder in an organic solvent, water, or mixture thereof. Wet milling can allow for reduction of particle sizes as well as protection of the particle surface from being exposed to air during milling. The binder can be a polymer binder such as paraffin wax, PVA, PEG, PVB, PVP, PMMA, micro-crystalline wax, and other similar polymeric materials, or mixtures thereof. The slurry can also include other ingredients, such as plasticizers, deflocculating agents, surfactants, or mixtures thereof.

The slurry can be granulated to form substantially spherical granules, wherein each granule comprises an agglomeration of particulate source metal. In some cases, granulating can be performed by spray drying the slurry. Spray drying is a technique used in materials processing, food processing, pharmaceutical and other industries for drying slurries to make granulated powders. The granulation can also be accomplished by other techniques such as, but not limited to, rotary drying techniques, vibratory pelletizing techniques, and freeze drying and other granulation techniques.

The average granule size of the granules after granulation can typically be in the range of about 20% to about 50% larger than the expected average final particle size of the granules depending on how densely the source metal particles are packed within each granule. Although size can vary, the granules can have an average size from 20 μm to 100 μm, or from 20 μm to 40 μm, or from 50 μm to 100 μm. In some embodiments, the granules can be sorted by size. The granules can then be sieved and classified into different size cuts depending on desired final particle size. The granules can be substantially spherical.

The granules can be debinded and sintered as a next step in the GSD process. Debinding can be carried out in a number of ways including thermal debinding and solvent debinding. Debinding and sintering of the granules can be carried out in the same furnace, especially for Ti powders, to avoid exposure of the powder to air after the polymeric binders are removed. However, the debinding and sintering can also be done in two separate steps, which may have advantages in some cases. Some or all of the binder can be removed during the debinding step. Therefore, debinding can be performed by holding the granules at a debinding temperature for an amount of time sufficient to remove the desired amount of binder. In some cases, the debinding temperature can be from about 50° C. to about 400° C. In some embodiments, the debinding temperature can be from about 150° C. to about 350° C. The debinding time can also vary depending on the particular binder. In some cases, the debinding time can be from about 1 hour to about 100 hours. The debinding can also proceed until a predetermined amount of binder is removed. For example, debinding can proceed until at least 90% of the binder has been removed, and in most cases substantially all of the binder is removed. Those of skill in the art will appreciate that different polymer binders can require different debinding temperatures, multiple debinding temperature stages, and times.

According to the GSD process, the debinded granules can be partially or fully sintered at a sintering temperature such that particles within each granule fuse together to form sintered granules. Debinding and sintering can be done in the same furnace as two separate steps. Especially for Ti, debinding in a separate furnace from that used for sintering may cause oxygen content to increase during the transfer from the debinding furnace to the sintering furnace. Thus, performing both debinding and sintering in the same furnace can allow for avoidance of contact with air which can cause oxidation or contact with oxygen. However, debinding and sintering can also be done in two separate furnaces as two separate steps. Debinding and sintering in two separate furnaces has practical advantages of not tying up a high temperature sintering furnace for too long. An increase in oxygen in the material can be dealt with in a subsequent de-oxygen process. Sintering can be conducted in a controlled inert gas atmosphere that may be vacuum, argon, hydrogen, nitrogen (for TiN powder), or mixtures thereof. Sintering conditions can be chosen to facilitate sintering of metal powders within each granule while minimizing inter-granule bonding. The partial sintering can be performed at a sintering temperature from about 700° C. to about 1400° C., and in some cases 900° C. to about 1000° C. Suitable sintering temperatures are similar for CP—Ti and Ti-6Al-4V alloy. The partial sintering can also be performed for a sintering time from about 1 second to about 100 hours, and often less than 24 hours. In some embodiments, the sintering time can be from about 30 minutes to about 1 hour. Pressure conditions are generally atmospheric or held under pressure. In other embodiments, sintering can proceed until the sintered granules reach a predetermined level of densification. In one specific embodiment, the partial sintering is performed until the partially sintered granules reaches from about 60% to about 80% densification, and often at least 65%.

In a further embodiment, the partial sintering can proceed until the debinded granules are fully sintered while retaining frangibility and/or separability. For example, sintered granules can fuse together at contact points between the granules but the granules retain unfused surface area sufficient to allow individual granules to be recovered. Typically, an unfused surface area of at least about 30% will allow the sintered frangible body to be crushed and individual granules recovered. In some cases, unfused granule surface area can be substantially 100% such that the sintered granules are not connected and are a loose collection of independent granules. Accordingly, sintering of the debinded granules can also be performed until each sintered granule is substantially free from bonding to each other.

After sintering, if the granules are bonded to each other in a frangible body, the frangible body can be subjected to ball milling or other crushing techniques to break up the contacts between sintered granule particles. Other methods can also be used to break the frangible body. This forms the substantially spherical metal powder. The substantially spherical powder can include spherical or nearly-spherical particles. Spherical or near-spherical includes particles which are suitable for 3D printing and which have dimensions which are low aspect ratio and avoid jagged or irregular shapes. In some embodiments, the substantially spherical metal powder can have an average particle aspect ratio less than about 1.5. In further embodiments, the average particle aspect ratio can be less than about 1.1. As used herein, “aspect ratio” refers to the longest dimension of a particle divided by the shortest dimension of the particle. Any of the steps described above for the GSD processes can be used to form a titanium feedstock for use in the additive manufacturing methods described herein.

In other examples of the methods of making densified sintered titanium articles described herein, the titanium feedstock can be prepared using the hydrogen-assisted magnesiothermic reduction of TiO₂ (HAMR) process. The HAMR process can be used to make titanium powder from TiO₂. In some examples, the TiO₂ used as a starting material for the HAMR process can be TiO₂ slag. A variety of other raw materials can also be used, including natural materials extracted from the earth and/or pre-processed materials, such as natural rutile (TiO₂), ilmenite (FeTiO₃), and leucoxene (an alteration product of titanium containing minerals). Such materials may be composed of varying degrees of titania. In one aspect, the TiO₂-slag can be obtained by carbothermally reducing a titanium feedstock comprising ilmenite, and/or leucoxene, which can be done in a reactor. Specific conditions can vary, however as a general guideline, such carbothermal reduction can include heating to a temperature from about 1000° C. to 1600° C. The result is TiO₂-slag, which in addition to TiO₂ includes other reaction products or impurities, such as pig Fe. Typically, TiO₂-slag can include from 70 to 85 wt % TiO₂.

The TiO₂-slag used in the HAMR process can also include what is known as “upgraded slag” or UGS. UGS is typically produced by purifying regular Ti-slag by a series of leaching processes. UGS is typically composed of greater than 90% TiO₂. UGS is similar in TiO₂ content to another industrial product that is called “synthetic rutile.”

In the HAMR process, TiO₂-slag is reduced using a metallic reducing agent to directly produce titanium metal chemically separated from metal impurities in the TiO₂-slag. Chemically separated indicates that the titanium is not alloyed or chemically bonded with other metal impurities. Direct reduction can be implemented by placing the TiO₂-slag in a temperature-controlled vessel at low pressure and mixing it with a metallic reducing agent in a hydrogen atmosphere. Temperature control can generally be within a range of about 500° C. to about 1200° C. In one aspect, the metallic reducing agent includes Mg, MgH₂, and/or CaH₂. The metallic reducing agent can be introduced in at least stoichiometric amounts, and in some cases up to about 6 times the mole amount of Ti.

In one aspect of the HAMR process, the TiO₂-slag can be ground to small particles and mixed with MgH₂ or other reducing agent. The initial particle size of TiO₂-slag can affect the kinetics of the reaction and/or the particle size of the reaction product. The slag particle size can be sized to avoid dissolution of TiH₂ during subsequent leaching processes (discussed below), but also to avoid oxidation in the final product. Particle size of TiO₂-slag can typically be from 0.1 micrometer to 5000 micrometers, and in many cases between 10 to 100 micrometers. Typically, the particle size of titanium hydride will depend on the original slag particle size, reaction temperature, and time. In another aspect, milling the TiO₂-slag can also enhance the degree of conversion. Suitable particle sizes can vary, however sizes from 10 to about 50 μm can provide good results.

The TiO₂-slag may include various impurities, such as iron (Fe), magnesium (Mg), calcium (Ca), aluminum (Al), silicon (Si), and vanadium (V). In the HAMR process, the TiO₂-slag can be reduced with a metallic reducing agent in a hydrogen atmosphere, which can convert the titanium in the slag from the oxide to titanium metal and titanium hydride (TiH₂). Because of its unique chemical and physical properties, including insolubility in water and resistance to solutions of moderate acidity, Ti can be separated from impurities by one or more known physical and chemical extractive metallurgy techniques, for example, magnetic separation, gravimetric separation, centrifugal separation, ammonia chloride leaching, alkaline leaching, and dilute acid leaching. The HAMR process can include such known methods for separating Ti from impurities. The aforementioned physical and/or chemical separation methods are generally well established in the extractive metallurgy industry and the research community. Thus, by directly reducing TiO₂-slag using the HAMR process, Ti can be chemically separated from other impurity elements in the slag without using the conventional high temperature processes, and can be further separated from the impurities by a series of chemical leaching and/or separations steps.

For example, when MgH₂ is used to react with TiO₂-slag under hydrogen, TiH₂ is formed. By forming TiH₂, Ti is chemically separated from the rest of the compounds in slag. Forming TiH₂, rather than Ti metal, is advantageous because Ti metal is more prone to forming alloys with other elements such as Fe, which can be difficult to separate. In addition, TiH₂ has very unique chemical properties. It is insoluble in water, resistant to moderate acid solutions, and has minimum or no solubility for other impurities in the slag. Furthermore, TiH₂ is impervious to oxygen pickup compared to Ti metal, which helps to keep oxygen levels low in the final metal product. It should be noted that the insolubility of TiH₂ in water is attributed to its kinetic passivation by water. These properties set up a condition by which the product of the direct reduction of TiO₂-slag can be sequentially leached to remove other impurity elements to separate and purify the TiH₂. Although the chemical resistance of TiH₂ enables it to be separable from other impurities, if the particle size of TiH₂ is too small, e.g. in the sub-micrometer scale, it can become soluble in those solutions.

The HAMR process can also include the use of molten salts in the reduction process because the kinetic rates of the reactions can be improved by the use of the liquefied salt. Specifically, molten salts have very high conductivity and facilitate electron transfer during the reduction reaction. Molten salt also has the effect of dissolving by-products such as MgO or CaO during the reduction process. The use of molten salts can also help to increase the particle size of TiH₂. In addition to mono-metal chloride, binary salts such as MgCl₂+NaCl, MgCl₂+KCl, and MgCl₂+CaCl₂) can be used along with other binary and ternary salt mixtures.

If TiH₂ is in the product of the reduction process, it can be readily converted to elemental Ti by dehydrogenation. Heating TiH₂ to a temperature above about 400° C. in vacuum or at pressures lower than the equilibrium pressure of H₂ at the corresponding temperature can release the hydrogen. In another embodiment, the heated hydrogen atmosphere may be replaced with argon to facilitate dehydrogenation. When the reaction product is TiH₂, it can be separated from other elements in the mixture by using physical and chemical separation processes. It can also be dehydrogenated first before being subjected to the physical and/or chemical separation processes. The final product of the HAMR process can be titanium metal powder that has an average particle size within the ranges described above. This titanium powder can be suitable for use in the additive manufacturing methods described herein.

In still further examples, the titanium feedstock used in the methods of making densified sintered titanium articles described herein can be prepared using the direct reduction and alloying (DRA) process. The DRA process includes forming a particulate oxide mixture including titanium oxide powder and at least one alloying element powder. The titanium oxide and alloying element can be co-reduced using a metallic reducing agent in a full or partial hydrogen atmosphere. The raw titanium oxide starting material for DRA can include any of the starting materials used in the HAMR process described above. In some examples, the raw titanium starting material can include natural rutile (TiO₂), ilmenite (FeTiO₃), leucoxene, TiO₂-slag, upgraded slag (UGS), Ti₂O₃, Ti₅O₉, or others.

The titanium raw material can be mixed at least one alloying element powder. The alloying element powder can include elemental metals, metal oxides, metal hydrides, or combinations thereof. In one case, the at least one alloying element powder is a metal oxide powder. Non-limiting examples of suitable metal oxide powder can include Al₂O₃, V₂O₅, CuO, MnO, V₂O₃, Fe₂O₃, Nb₂O₅, ZrO₂, MoO₃, MoO₂, Cr₂O₃, SnO₂, SiO₂, Ta₂O₅, CoO, WO₃, NiO, and combinations thereof including oxides of elements in the above list with varying valence states. For example, V₂O₃ can allow for better wettability and lower dwell times or temperatures than V₂O₅ during sintering (i.e. homogenization steps).

Alternatively, or in addition, the at least one alloying element powder can include an elemental metal. Non-limiting examples of suitable elemental metals include Al, Mo, V, Nb, Ta, Fe, Cr, Mn, Co, Cu, W, Zr, Sn, Ni, Si, and combinations thereof. In one example, the at least one alloying element powder can include a metal hydride. Non-limiting examples of suitable metal hydrides include aluminum hydride, vanadium hydride, niobium hydride, tantalum hydride, zirconium hydride, silicon hydride, and combinations thereof.

In one example, the alloying element powder can also include a mixture of oxides and elemental powder. Regardless, the choice of alloying element powders can depend on the desired titanium alloy product. Appropriate molar ratios of elemental metals in feed powder can be chosen in order to produce a desired alloy. Non-limiting examples of titanium alloys which can be produced include Ti-6Al-4V, Ti-2.5Cu, Ti-8Mn, Ti-3Al-2.5V, Ti-5Al-2.5Fe, Ti-6Al-7Nb, Ti-13Nb-13Zr, Ti-15Mo-5Zr, Ti-10V-2Fe-3Al, Ti-8V-3Al-6Cr-4Mo-4Zr, Ti-6Al-2Sn-4Zr-2Mo-0.1Si, Ti-15Mo-3Al-2.7Nb-0.25Si, Ti-15Mo-2Sn-4Zr-4Mo-2Cr-1Fe, and the like.

Co-reduction of the mixture of titanium oxide and alloying element can include exposing the mixture to the metallic reducing agent under a hydrogen atmosphere at a reducing temperature to produce a hydrogenated titanium alloy product. Typically, the metallic reducing agent as a solid particulate can be physically mixed with the titanium oxide mixture and then heated to a reducing temperature. The metallic reducing agent can have a stronger oxidation potential than that of titanium. The presence of hydrogen helps to destabilize Ti—O system and make it easier for the reduction of oxide mixture by the metallic reducing agent. After the reduction, the reduced product is cooled from the reduction temperature to room temperature. Maintaining a hydrogen atmosphere during cooling will lead to formation of titanium hydride. The exact content of hydrogen in the Ti alloy depends on the specific temperatures and the dwell time at those temperatures. Typically upon furnace cooling, the titanium product at the end will be titanium hydride products with 3-4 wt % of hydrogen. The co-reduction step produces the hydrogenated titanium alloy product chemically separated from metal impurities. Chemically separated indicates that the titanium is not alloyed or chemically bond with other metal impurities other than the alloying elements.

The metallic reducing agent used in DRA can be one of the reducing agents described above in the HAMR process, in some examples. In further examples, the metallic reducing agent can be at least one of a magnesium reducing agent and a calcium reducing agent. In one example, the metallic reducing agent is the magnesium reducing agent including Mg. MgCl₂ can optionally be added and mixed in to help facilitate the reaction. In principle, the reduction reaction can proceed with only Mg and H₂. However, in order to increase the kinetic rate of the reaction, the reaction can be carried out in a molten salt medium. For example, MgCl₂ can be used. At the reaction temperature, MgCl₂ is in a molten state which facilitates the reaction, but does not participate in the reduction reaction. In addition to mono-metal chloride, binary salts such as MgCl₂+NaCl, MgCl₂+KCl, and MgCl₂+CaCl₂) can be used along with other binary and ternary salt mixtures. Reducing temperatures for magnesium reducing agents can generally range from about 600° C. to about 950° C. and most often 645° C. to 800° C. The reducing agent can be present at a mass ratio of oxides to reducing agent from 1:1 to 1:5, and most often about 1:1 to 1:2. Alternatively, the metallic reducing agent can be one or both of Ca and CaH₂. Calcium can be effective, although reduction temperatures tend to be about 750° C. to 850° C. which is generally higher than Mg reducing agents. Regardless of the reducing agent chosen, the reducing temperature can be sufficient to maintain the metallic reducing agent in a molten state during co-reduction.

The DRA process can also include heat treating the reduced hydrogenated titanium alloy to reduce pore size and specific surface area. This heat treatment can be performed under a hydrogen atmosphere. The heat treating can also produce a more uniform particle size and exterior surface morphology. As an example, the heat treating temperature can be from 700° C. to 1500° C., and in some cases about 1100° C. Further, a hydrogen atmosphere can be introduced when the hydrogenated titanium alloy product is heated to the heat treating temperature. During heat treatment, inert gas may be used while heating the hydrogenated titanium alloy product to the heat treating temperature and then switched to hydrogen atmosphere (e.g. optionally mixed with inert gas). Heat treatment can include a dwell time at the heat treatment temperature under the hydrogen atmosphere. Although conditions can vary, dwell times of about 1 minute to 10 hours can be sufficient, and most often from 1 to 4 hours. Cooling from heat treatment can generally include maintenance of at least sufficient hydrogen gas to maintain hydrogenation of the hydrogenated titanium alloy product.

The DRA process can also include deoxygenating the heat treated hydrogenated titanium alloy to reduce residual oxygen to less than 0.3 wt %. The deoxygenating can be accomplished by heating the heat treated hydrogenated titanium alloy with a deoxygenation agent at a deoxygenation temperature and again under a hydrogen atmosphere. Non-limiting examples of suitable deoxygenation agents includes Mg, Ca, and CaH₂. Typically, the deoxygenation can be facilitated using a molten salt as a deoxygenation medium to increase kinetic rates of reaction. Examples of molten salts can include, but are not limited to MgCl₂ and CaCl₂). In another specific example, the molten salt can be a calcium halide eutectic salt including CaCl₂) and at least one of KCl, LiCl and NaCl. Non-limiting examples of calcium salts can include CaCl₂), CaBr₂, CaI₂, CaCl₂)—LiCl, CaCl₂)—KCl, CaCl₂)—MgF₂, CaCl₂)—LiF, CaCl₂)—KF, CaCl₂)—NaF, CaCl₂)—NaBr, CaCl₂)—LiBr, CaCl₂)—KBr, CaCl₂)—NaI, CaCl₂)—LiI, CaCl₂)—KI, CaBr₂—LiCl, CaBr₂—KCl, CaBr₂—MgF₂, CaBr₂—LiF, CaBr₂—KF, CaBr₂—NaF, CaBr₂—NaBr, CaBr₂—LiBr, CaBr₂—KBr, CaBr₂—NaI, CaBr₂—LiI, CaBr₂—KI, CaI₂—LiCl, CaI₂—KCl, CaI₂—MgF₂, CaI₂—LiF, CaI₂—KF, CaI₂—NaBr, CaI₂—LiBr, CaI₂—KBr, CaI₂—NaI, CaI₂—LiI, CaI₂—KI, CaCl₂)—CaBr₂, CaCl₂)—CaI₂, CaCl₂)—CaF₂, CaBr₂—CaI₂, CaBr₂—CaF₂, CaI₂—CaF₂, and combinations thereof.

Generally, a calcium halide eutectic salt can be mixed with solid calcium in the presence of the titanium alloy product at temperatures below the melting point of calcium. The calcium halide eutectic salt can be formed by mixing calcium halide with an alkali metal halide and heating to a eutectic melting temperature below the melting temperature of calcium (i.e. 842° C.). Most often the eutectic melting temperature can be at least 30° C. below the temperature of deoxygenation. In another specific example, the deoxygenation agent is Mg with MgCl₂ as a molten salt medium. Deoxygenation can also utilize a modest amount of deoxygenation agent. For example, a heat treated hydrogenated titanium product to deoxygenation agent mass ratio of 1:0.2 to 1:1 can be suitable.

The titanium alloy powder produced using DRA can be used in its hydride form after the steps of co-reducing, heat treating, and deoxygenation have been completed. Alternatively, the titanium alloy hydride can be dehydrogenated by heating the powder in a hydrogen deficient atmosphere. The heating can be performed until the hydrogen content of the powder is less than about 100 ppm by mass. The dehydrogenation temperature can be from 400° C. to 800° C.

Whether the titanium feedstock is prepared using the GSD process, HAMR process, DRA process, or another process, it can be useful for the titanium feedstock to include spherical particles are nearly spherical particles. Spherical particles can have good flowing properties that can allow the powder to be deposited and spread in even layers on a powder bed. The spherical particles can also provide a predictable packing density, which can be useful for 3D printing. In some examples, the titanium feedstock particles can have a sphericity greater than 0.6, or a sphericity greater than 0.8, or a sphericity greater than 0.9. In further examples, the titanium feedstock particles can have a sphericity up to about 0.98. In a particular example, the sphericity can be from 0.92 to 0.98. In a more specific example, the titanium feedstock can be prepared using the GSD process and the sphericity can be from 0.92 to 0.98. In another example, the titanium feedstock can be prepared using the HAMR process and the sphericity can be from 0.6 to 0.9. As used herein, sphericity is defined as the ratio of the surface area of a perfect sphere having the same volume as a particle to the actual surface area of the particle, with values closer to 1.0 being closer to a perfect sphere.

The surface of the titanium feedstock particles may have different surface morphologies depending on the type of process used to prepare the titanium feedstock. In some examples, the surface of the titanium feedstock particles can include hills and/or valleys that have a hill height or valley depth up to about 1/10 of the particle diameter. In other examples, the hills and valleys can be up to about 1/20 of the particle diameter, or up to about 1/30 of the particle diameter.

A binder can be applied to the titanium feedstock to bind the titanium feedstock particles together, forming a green body as shown in FIGS. 2A-2D. In various examples, the binder can be in the forming of a liquid, an aqueous solution, a dispersion, a slurry, or other forms. In certain examples, an organometallic binder can be used. The organometallic binder can include metal salts bonded to organic ligands. The organometallic can be dissolved in a solvent, which allows the solution to be easily printed from a printer such as inkjet printer or other liquid ink printer. The binder can be cured by heating, which causes metal nanoparticles to precipitate from the metal salt and these metal nanoparticles can form metallic connections between titanium feedstock particles in the green body.

In further examples, the binder can include an organic polymer such as a polyacrylic, polymethacrylic, poly(methyl methacrylate), polystyrene, poly(vinyl alcohol), polycarbonate, or others. In one example, the binder can be a resin such as, but not limited to, epoxy, vinylesters, polyesters, and resin composites (e.g. carbon fiber resins, fiber resins, aramid fiber resins such as KEVLAR, and the like). In alternative examples, the binder can be a gel binder or gel-forming binder. For example, the binder can be a liquid that forms a gel after being applied onto the powder bed. The gel formation can be triggered by evaporation of solvent, chemical reaction with the build material, chemical reaction with another reactant applied to the build material, change in pH, or another trigger. In one example, the binder can include silica and the silica can form silica gel after the binder is applied to the powder bed. However, binders that include silica may be difficult to completely remove from the green body, and therefore can leave silicon residue in the sintered titanium article. In some examples, the binder used in the methods described herein can be silicon-free or substantially silicon-free so that the binder does not increase the amount silicon impurity in the final densified sintered titanium article.

In further examples, the binder can be curable by heat curing, ultraviolet curing, curing using other radiation, or another curing process. The methods described herein can also include a curing step in some examples. The curing step can be performed for the entire green body after the green body has been fully printed, or curing steps can be performed for each individual slice of the green body during the printing process.

The strength of the green body can be related to the amount of binder that is applied. In some examples, the titanium feedstock can be saturated with binder during printing, meaning that a sufficient amount of binder is applied to completely fill void spaces between the titanium feedstock particles. In other examples, the titanium feedstock can be partially saturated. In many cases, the titanium feedstock particles can be bound together by a thin layer of binder, with some void spaces remaining between the particles. If the binder contains carbon, then increasing the amount of binder in the green body may increase the amount of carbon impurity present in the final densified sintered titanium article. On the other hand, using too little binder can result in a fragile green body that does not hold together. Additionally, if the amount of binder applied to the powder bed during printing is not sufficient to penetrate through the thickness of a layer of powder to the layer below, then the individual layers or slices of the green will not be bound together. Thus, the amount of binder applied can be adjusted to balance these characteristics. In some examples, the amount of binder in the green body can be from 0.1% to 5% by weight of the green body. In further examples, the amount of binder can be from 0.1-1%, or from 1% to 3%, or from 3% to 5%, or from 1% to 2%, or from 2% to 3% by weight of the green body. If the binder is applied in the form of a solution, then these amounts can refer to solid binder that is left in the green body after the solvent has evaporated.

The green body can be debinded to remove at least a portion of the binder before sintering. The binder can volatilize at a debinding temperature, allowing the volatilized binder to be easily removed from the green body. The temperature at which the binder volatilizes can be from 200° C. to 450° C. in some examples. Accordingly, the methods described herein can include a step of debinding the green body to remove at least a portion of the binder. The debinding can be performed at a debinding temperature for a debinding time. The debinding temperature and debinding time can be sufficient to remove 97% or more of the binder in some examples. In further examples, the debinding temperature can be less than about 600° F., or from about 300° F. to about 600° F. The debinding time can be from about 1 minute to about 24 hours, or from about 10 minutes to about 8 hours, or from about 30 minutes to about 4 hours, or about 1 hour, in various examples. The debinding can also be performed in an oxygen free atmosphere or vacuum or hydrogen-containing atmosphere to prevent addition of oxygen to the green body. In a particular example, the debinding can be performed under vacuum with hydrogen backfill. If a small amount of binder remains after the debinding, in some cases the remaining binder can be volatilized during sintering. In some examples, the binder can leave substantially no carbon residue in the final densified sintered titanium article.

Regarding the process of applying the binder to the titanium feedstock, the binder can be selectively applied to layers of titanium feedstock particles. The individual layers of titanium feedstock particles can be formed by depositing unbound titanium feedstock particles at a desired layer thickness. In some examples, the layer thickness can be from about 10 μm to 100 μm. In further examples, the layer thickness can be from about 60 μm to 100 μm, and in other examples the layer thickness can be about 90 μm. The layer thickness can be controlled by the distance that the build platform is dropped between layers, as shown in FIGS. 2A-2D. The particle size of the titanium feedstock can be less than the layer thickness. In some examples, the average particle size of the titanium feedstock can be less than 40% of the layer thickness, or less than 33% of the layer thickness, or less than 20% of the layer thickness, or from 5% to 40% of the layer thickness, or from 5% to 33% of the layer thickness.

When the green body is printed, the green body may have a lower density than the final densified sintered titanium article. In some examples, the green body can have a green density of 40% to 70% by volume, and in some cases up to about 80% by volume.

After debinding, the green body can be sintered at a sintering temperature, which can be higher than the debinding temperature. The methods described herein can utilize the HSPT (hydrogen sintering and phase transformation) process as mentioned above. In this process, sintering can occur in a dynamically controlled hydrogen atmosphere at an elevated sintering temperature. This can produce a sintered titanium article that contains hydrogen. The dynamically controlled hydrogen atmosphere contains primarily hydrogen that was not produced from the particulate titanium feedstock material. In traditional approaches to sintering TiH₂, hydrogen gas can often be liberated from the titanium material during sintering at a high temperature. When sintering is performed under a vacuum, the titanium material can often be completely dehydrogenated during the sintering process. In such a process, the atmosphere surrounding the titanium part during sintering is a near-vacuum with only a small pressure of hydrogen as the hydrogen is driven off from the titanium. In processes according to the present technology, however, the sintering step can be performed under a dynamically controlled hydrogen atmosphere that primarily includes hydrogen from an external source. This dynamically controlled hydrogen atmosphere can be used to control the concentration of hydrogen in the titanium material during sintering, equilibrating, and phase transformations including eutectoid decomposition.

Controlling the hydrogen pressure during sintering, equilibration, and phase transformations including eutectoid decomposition can allow for high sintered densities and fine grain sizes in the final titanium material. In some embodiments of the present technology, the sintering can be performed under an atmosphere with an appropriate pressure of hydrogen such that the titanium material remains in a β-Ti(H) solid solution phase region during sintering. In such embodiments, the material is a solid solution of β-phase titanium with hydrogen at the sintering temperature, rather than a pure titanium metal as would be the case under a vacuum. The titanium can be sintered to very high density at high temperatures, e.g. in the β-phase region, under controlled hydrogen partial pressure with significant hydrogen content in the metal. Without being limited to one particular mechanism, it is believed that self-diffusion of the titanium in the 3-Ti phase is significantly faster than in the α-Ti phase, and a solid solution of hydrogen atoms in titanium can reduce the activation energy of Ti self-diffusion due to the presence of Ti—H bonds, which have a significantly decreased bond strength in relation to Ti—Ti bonds. It is believed that each of these effects helps to achieve full densification during β-Ti(H) sintering.

The dynamically controlled hydrogen atmosphere can include pure hydrogen or a mixture of hydrogen and an inert gas, such as helium, argon, or xenon. The partial pressure of hydrogen can typically be between 0.01 atm and 10 atm. In some embodiments, the dynamically controlled hydrogen atmosphere has a hydrogen to inert gas ratio from about 1:100 to about 1:0. In certain examples, the ratio of hydrogen to inert gas can be from about 40/60 to about 60/40, or from about 45/55 to about 55/45, or about 50/50 by volume. The total pressure of hydrogen with the inert gas can be any pressure, but in many embodiments the total pressure can be between about 0.01 atm and 10 atm of absolute pressure. Therefore, the partial pressure of hydrogen may be controlled by, but not limited to, one of several methods. In one method, the absolute pressure of the system is constant and the partial pressure of hydrogen is controlled using two programmable gas mass flow controllers; one being connected to a supply of hydrogen and the other to a supply of inert gas. The partial pressure of hydrogen is increased by increasing the volume fraction of hydrogen flowing into the system and vice versa. In another method, the partial pressure of hydrogen is controlled by controlling the absolute pressure of the system using a programmable pressure controller with an inlet valve to increase absolute pressure and an exhaust valve to decrease absolute pressure. The inlet valve of the pressure controller is connected to a supply of either pure hydrogen or a mixture of hydrogen and inert gas with a fixed ratio. Additionally, a hybrid method may be used where the volume fraction of hydrogen on the inlet valve of the pressure controller is controlled using two programmable gas mass flow controllers. In any method, the partial pressure of hydrogen is equal to the product of the absolute pressure of the system and the overall volume fraction of hydrogen in the system. In some embodiments, the absolute pressure of the system can be maintained at a substantially constant controlled absolute pressure. However, controlling the pressure can involve merely maintaining pressure within the desired hydrogen partial pressure ranges. Under conditions using pure hydrogen (i.e. the hydrogen atmosphere consists essentially of hydrogen), the corresponding process pressure can be at a controlled absolute pressure corresponding to the above recited hydrogen partial pressures. Specifically, pure hydrogen can generally be from 0.01 atm to 10 atm.

In some embodiments, the dynamically controlled hydrogen atmosphere can be varied throughout the sintering, equilibrating, and phase transformations including eutectoid decomposition steps to offer further microstructural control. Exact hydrogen pressure can be selected based on the equilibrium pressure as a function of the temperature and the desired hydrogen content necessary to produce a particular microstructure. More specifically, as temperature decreases, equilibrium pressure of hydrogen gas over the surface of titanium with a given concentration of dissolved hydrogen decreases. Therefore, the sintered material will absorb additional hydrogen at lower temperatures given a constant partial pressure of hydrogen. As such, the dynamically controlled hydrogen atmosphere can include a hydrogen partial pressure which is varied during the process in order to achieve a target hydrogen concentration within the sintered titanium material as a function of time. For example, if a constant hydrogen content is desired then as temperature decreases, the partial pressure of hydrogen would also be decreased commensurate with the equilibrium pressure. Alternatively, the hydrogen content can be varied as a function of time throughout the process to achieve the desired microstructure. In one embodiment, the hydrogen partial pressure is kept at 1 atm during the sintering step to maintain elevated levels of hydrogen within the titanium during sintering, the atmosphere is then gradually changed to 0.5 atm of hydrogen as the sample cools to the phase transformations including eutectoid decomposition temperature to prevent excessive absorption of hydrogen. In any embodiment, if the equilibrium pressure of the titanium-hydrogen system, which is a function of temperature and hydrogen content of the titanium, is different than partial pressure of hydrogen in the atmosphere, hydrogen evolution or absorption will occur. Therefore, using one of the methods described above, or a similar method, to control the partial pressure of hydrogen throughout the process can prevent excessive evolution or absorption. Using Ti-6Al-4V as an example, under a partial hydrogen pressure, blended powder can be sintered to near full density with a microstructure having one, two, three, or four phases including alpha (α), alpha-2 (α₂), delta (δ) and beta (β) phases after cooling to room temperature.

After the sintering step, the phase transformations including eutectoid decomposition can also be performed under a dynamically controlled hydrogen atmosphere containing hydrogen. Controlling the hydrogen content in the titanium material during the eutectoid phase transformation from β-phase to α-, and δ-phases can allow for titanium materials with very fine microstructure without resorting to thermo mechanical working that relies on recrystallization to control grain sizes. The equilibrium transformation temperature decreases and the kinetics of the transformation reaction slow with increasing hydrogen concentration. Additionally, the hydrogen concentration is a function of temperature and partial pressure of hydrogen in the atmosphere. Therefore, the thermodynamics and kinetics of the phase transformations are dependent not only on temperature (as is the case with most metallurgical processes), but also on the partial pressure of hydrogen in the atmosphere. In some embodiments, the partial pressure of hydrogen used during sintering could result in excessive uptake of hydrogen at the decomposition temperature, which would result in reduced undercooling and slowed kinetics. Conversely, in these embodiments, a simultaneous decrease of hydrogen partial pressure during cooling can prevent an inordinate uptake of hydrogen. Decreasing the partial pressure could result in a greater degree of undercooling and faster kinetics at the decomposition temperature, which would, in turn, result in a finer microstructure due to more homogenous nucleation and a greater degree of reaction completion per unit time. This phenomenon gives the process another parametric degree of freedom and, therefore, greater control over microstructural evolution. In one embodiment, the hydrogen partial pressure can gradually decrease from 1 atm of pure hydrogen at the sintering temperature to 0.5 atm hydrogen and 0.5 atm of inert gas at the decomposition temperature. The atmosphere can then be abruptly changed to 1 atm of inert gas with no hydrogen immediately before cooling to prevent excessive absorption of hydrogen.

In some embodiments, the partial pressure of hydrogen in the dynamically controlled hydrogen atmosphere can change with each step. For example, in one embodiment the process can include sintering blended powders of TiH₂ and alloying powders in a dynamically controlled hydrogen atmosphere with a first partial pressure of hydrogen, cooling and holding for phase transformations including eutectoid decomposition under a second partial pressure of hydrogen, and then switching the atmosphere condition to vacuum, inert gas, or a combination of both to dehydrogenate the material. In other embodiments, a single partial pressure of hydrogen can be used throughout the sintering, equilibrating, and phase transformations including eutectoid decomposition steps. Furthermore, the partial pressure of hydrogen can be changed multiple times within a single step, or the partial pressure can be gradually ramped up or down over the duration of a step.

The elevated sintering temperature can be any temperature that corresponds to the β-phase region with a given hydrogen content. One of skill in the art will appreciate that the temperatures and compositions that fall within the β-phase region can be different for pure titanium and various alloys of titanium with other metals. In the first step of β-Ti(H) sintering, by controlling the H₂ atmosphere, the process maintains sintering in β-Ti phase region. Self-diffusion of the titanium in the β-Ti phase is significantly faster than in the α-Ti phase, and a solid solution of hydrogen atoms in titanium can reduce the activation energy of Ti self-diffusion due to the decrease of bonding strength due to the presence of comparatively weak Ti—H bonds. It is believed that each of these effects helps to achieve full densification during β-Ti(H) sintering.

In one exemplary embodiment, the sintered titanium material can be Ti-6Al-4V alloy. Under the partial hydrogen pressure, a blended powder can be sintered to near full density with a microstructure having one, two, three, or four phases including alpha (α), alpha-2 (α₂), delta (δ) and beta (β) phases after cooling to room temperature. The elevated temperature at which sintering occurs can be from about 1000° C. to about 1500° C. In one particular embodiment the elevated temperature can be about 1200° C. The sintering is also conducted for a time period sufficient to gain near full density. For example, the material can be held at the elevated temperature from about 1 hour to about 24 hours. In some embodiments, the sintering time can vary from about 30 minutes to about 30 hours. In other embodiments, the sintering can be performed from about 1 hour to 24 hours. In one particular embodiment, the sintering time can be about 2 hours.

The sintering can be conducted in any chamber in which the temperature and atmosphere can be controlled. For example, the sintering can be conducted in a furnace which is capable of attaining a working temperature of up to 1500° C. or even higher, is capable of being used under vacuum, and is capable of using gases such as hydrogen, argon, nitrogen, and the like, or a mixture of any two or more such gases. In one particular embodiment, the furnace can be an alumina tube furnace. In another embodiment, the furnace can be a refractory metal alloy including, but not limited to, a Fe—Cr—Al alloy. The heating elements of the furnace can be made of such materials as are known in the art, including, but not limited to, tungsten or molybdenum mesh, silicon carbide, or MoSi₂.

After sintering, an optional intermediate equilibration step can be introduced in order to allow hydrogen partial pressure to be adjusted dynamically to facilitate the following phase transformations including eutectoid decomposition step. In some embodiments this equilibrating step can include holding the sintered titanium material at a temperature above the β-transus prior to phase transformations including eutectoid decomposition to allow hydrogen within the sample to reach the desired equilibrium concentration for a desired phase evolution during phase transformations including eutectoid decomposition. The equilibration temperature can be below the sintering temperature and above the phase transformations including eutectoid decomposition temperature. The equilibration temperature can vary between about 300° C. and about 1000° C. or about 400° C. to about 900° C. Typically, the equilibration temperature for Ti-6Al-4V alloy can be from about 500° C. to about 900° C. The equilibration temperature can vary from one alloy composition to another. The temperature can be held constant, or nearly constant, during this step for from about 10 minutes to about 120 hours. The equilibration time can be sufficient for the hydrogen within the sample to reach equilibrium with the dynamically controlled hydrogen atmosphere and homogenize the sintered titanium material.

Optionally, an additional cooling step can be performed in which the sintered titanium material is cooled from the elevated sintering temperature to the equilibration temperature at a non-uniform rate. Another optional step prior to the phase transformations including eutectoid decomposition step can be performed in which the sintered titanium material is cooled from the equilibration temperature to the phase transformations including eutectoid decomposition hold temperature at a non-uniform rate. In one embodiment, the material can be cooled from the sintering temperature to the equilibration temperature at a rate of 10° C./min. After a sufficient amount of time for equilibration to a desired hydrogen content, the material can be cooled from the equilibration temperature to the decomposition temperature at a non-uniform rate, beginning at 10° C./min and decreasing to about 1° C./min as the target temperature is approached. A non-uniform temperature change rate can allow for increased microstructural control due to the diffusion of hydrogen that is being absorbed during temperature change as well diffusion of alloying elements being segregated to their respective phases during phase transformation. Regardless, phase transformation occurs during establishment of equilibrium or while absorbing hydrogen. Such phase transformation can also happen after equilibrium and during cooling to room temperature.

The phase transformations including eutectoid decomposition step can be performed by holding the sintered titanium material at a hold temperature and a hold time sufficient for phase transformations including eutectoid decomposition of the sintered titanium material. In some embodiments, the phase transformations including eutectoid decomposition step is conducted at a temperature from about 200° C. to about 900° C. The temperature can be below the β-phase transition temperature for whatever particular composition of Ti, H, and other alloying additives is being used. In some embodiments, the material can be held at the phase transformations including eutectoid decomposition hold temperature for a hold time from about 10 minutes to about 120 hours.

The sintered material can be cooled in the dynamically controlled H₂ atmosphere to cause phase transformations including eutectoid decomposition temperature below the β-transus. The material can then be held at this temperature for a period of time to complete the eutectoid reaction. As used herein, the term “eutectoid reaction” refers to the formation of new phases (α-Ti(H)+b-TiHₓ) that precipitate in the interior of β-Ti(H) grains in the sintered material. As a result, the coarse j-Ti(H) grains break into finely dispersed (α-Ti(H)+α₂+β-Ti(H)+δ-TiHₓ) grains, thereby refining the microstructure.

In some cases, the microstructure-controlled titanium article (after the phase transformation step) can be cooled to room temperature or close to room temperature before the dehydrogenation step. This cooling can be under an inert atmosphere, such as argon.

After the phase transformation step and optional cooling step, the sintered titanium material can be re-heated under vacuum or inert gas to dehydrogenate. The dehydrogenation temperature can be below the sintering temperature. The temperature for dehydrogenation in vacuum or inert gas can typically be from about 400° C. to about 900° C., below the β-phase transition temperature. In further examples, the dehydrogenation temperature can be from 600° C. to 800° C., or about 750° C. The sintered titanium material can be held at the dehydrogenation temperature from about 2 hours to about 100 hours depending on the size of the components.

During the step of dehydrogenation in vacuum and/or an inert atmosphere, the hydrogen atoms in the titanium are removed. The phase transformations during dehydrogenation further refine and modify the microstructure. The final fine grain microstructure can be formed during this step. According to various embodiments, if the material is a Ti-6Al-4V alloy, such fine grain microstructure includes both α-phases and β-phases. Without being bound by theory, the dehydrogenation process is believed to decompose the δ-phase and release the hydrogen in the material. During the dehydrogenation process, the δ-phase transforms to a α+β phase mixture. Hydrogen then diffuses through the material to the surface, where it escapes as hydrogen gas.

The re-heating of the material can be conducted for a time period sufficient to reduce hydrogen content in materials to less than 150 ppm. Generally, hydrogen can be removed to a level much lower than allowable levels according to ASTM standards (150 ppm). For example, the residual hydrogen content after conventional vacuum sintering of TiH₂ or thermohydrogen processing (THP) can be as low as 10 ppm, which is not detrimental to the mechanical properties of titanium materials. The hydrogen content of materials prepared using the processes of the present invention can be nearly as low. For example, in one embodiment the hydrogen present after performing the present process using vacuum during dehydrogenation has been measured at or below 30 ppm, and at or below 60 ppm when using Ar atmosphere during dehydrogenation. These are both well below the ASTM standard of 150 ppm. The time for dehydrogenation can vary depending on the size of the part being formed or the components used. The dehydrogenation step can be conducted by holding the material at the dehydrogenation temperature for from about 1 hour to about 100 hours. The actual time required is governed by the law of diffusion. According to some embodiments, dehydrogenation can be performed from about 10 to about 24 hours. In other embodiments, the dehydrogenation time can be from about 1 to about 20 hours. The dehydrogenation can be conducted in the same chamber as the initial sintering, or in a separate furnace chamber in which the temperature and atmospheric pressure and composition can be controlled.

The steps of sintering in the dynamically controlled hydrogen atmosphere, phase transformations including eutectoid decomposition in the dynamically controlled hydrogen atmosphere, and the dehydrogenation under vacuum, inert gas, or a combination of both, can be three separate processes, or they can be integrated in a single process. Alternatively, the sintering and phase transformations including eutectoid decomposition steps can be processed in sequence with the dehydrogenation step following later, or just the sintering step can be completed with the phase transformations including eutectoid decomposition and dehydrogenation steps being processed together later. In one embodiment, a single, integrated process of all three steps can be performed. This embodiment can include sintering blended powders of TiH₂ and alloying powders in a dynamically controlled hydrogen atmosphere with a partial pressure of hydrogen (H₂) gas, cooling and holding for phase transformations including eutectoid decomposition under the same or different partial pressure of H₂, and then switching the atmosphere condition to vacuum, inert gas, or a combination of both at certain temperatures to perform the dehydrogenation step. In another embodiment, after the sintering step, the parts are subjected to the dehydrogenation step directly without specifically holding for phase transformations. The parts may be cooled to room temperature before heating up to the dehydrogenation temperature, or the parts may be cooled from the sintering temperature to the dehydrogenation temperature directly without interruptions.

The titanium metal or titanium metal alloys obtained from the process can have a fine or ultrafine grain size (i.e. average grain size). Such ultrafine grain sizes on the microscopic scale provide for high strength and ductility in the macro scale materials. The grain size is primarily a function of the kinetics of phase transformation and the temperature versus time profiles as well as partial pressure of H₂ versus time profiles during the sintering, phase transformations including eutectoid decomposition, and dehydrogenation steps. In any of the above embodiments, the titanium metal or the titanium metal alloy obtained from the process can have a grain size of less than 100 μm. In some embodiments, the titanium metal or titanium metal alloy prepared using the above process can have a grain size of less than 10 μm. In some embodiments, the titanium metal or titanium metal alloy prepared using the above process can have a grain size of less than 20 μm and in some cases less than 5 μm. In other embodiments, the titanium metal or the titanium metal alloy can have a grain size of from about 10 nm to about 10 μm. These grain sizes can refer to the longest dimension of the grains. In other embodiments, the titanium metal or the titanium metal alloy can have a grain size of from about 10 μm to about 100 μm. These grain sizes and other properties recited herein are typically obtained directly from the process without further post-processing (i.e. as-sintered). Note the term as-sintered can be used to encompass the step of sintering at the high temperatures in hydrogen or all three steps of the process including sintering in hydrogen, phase transformations, and dehydrogenation. Accordingly, in some cases the process can consist essentially of sintering, holding to cause eutectoid decomposition, and heating to cause dehydrogenation.

Additionally, the titanium metal or titanium metal alloys obtained from the process can have a high relative density. In any of the above embodiments, the titanium metal or the titanium metal alloy can have a density greater than 95%, or greater than 97%, or from about 95% to about 99.5%. The titanium materials can be nearly fully dense (for example, greater than 99% relative density for CP—Ti and greater than 98% relative density for Ti-6Al-4V). These densities can be achieved by the HSPT process after the densified sintered titanium article has been dehydrogenated and then cooled. However, in some cases, an additional hot isostatic pressing (HIP) process can be used to further densify the titanium article. This HIP step is optional and may not be used in all cases.

The materials can also have lower oxygen content than equivalent titanium materials prepared using traditional powder metallurgy approaches, and can be substantially free of impurities. In some embodiments, the titanium metal or titanium metal alloy can have an oxygen content of less than 0.5 wt %. In other embodiments, the titanium metal or titanium metal alloy can have an oxygen content of less than 0.2 wt %. In other embodiments, the titanium metal or titanium metal alloy can have an oxygen content of from about 0.001 wt % to about 0.3 wt %.

The densified sintered titanium articles made using the methods described herein can have useful properties, including high tensile strength and elongation at break. In some examples, the ultimate tensile strength of the article can be greater than 1000 MPa. The elongation can also be greater than 10%.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology, thus generally described, will be understood more readily by reference to the following examples, which are provided by way of illustration and are not intended to be limiting.

### EXAMPLES

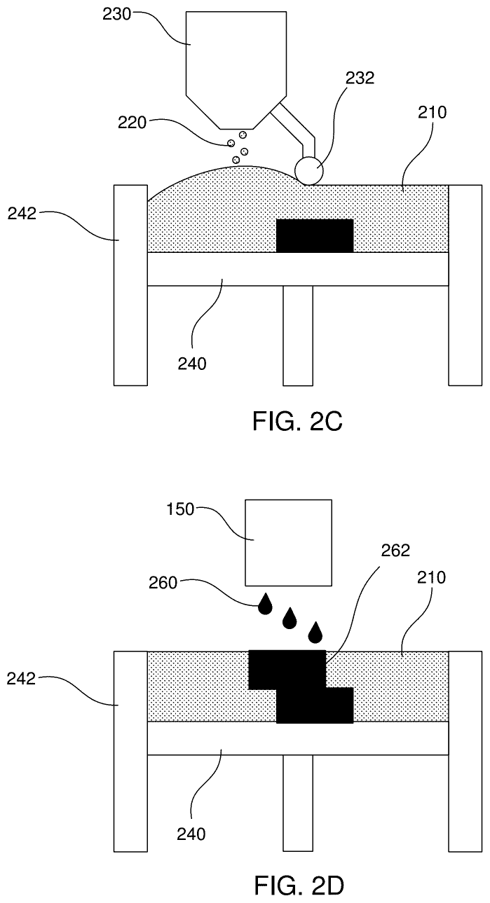

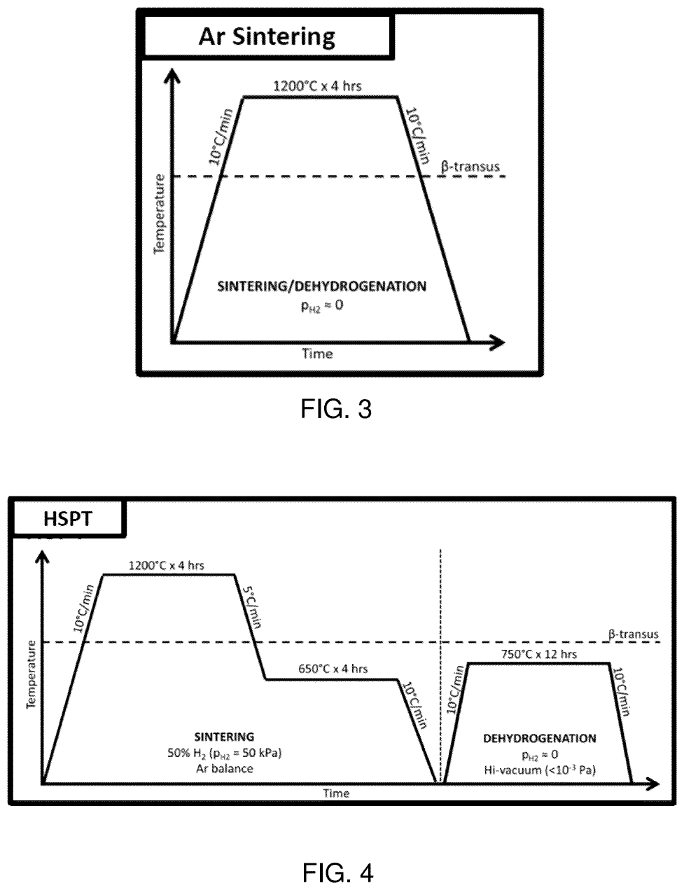

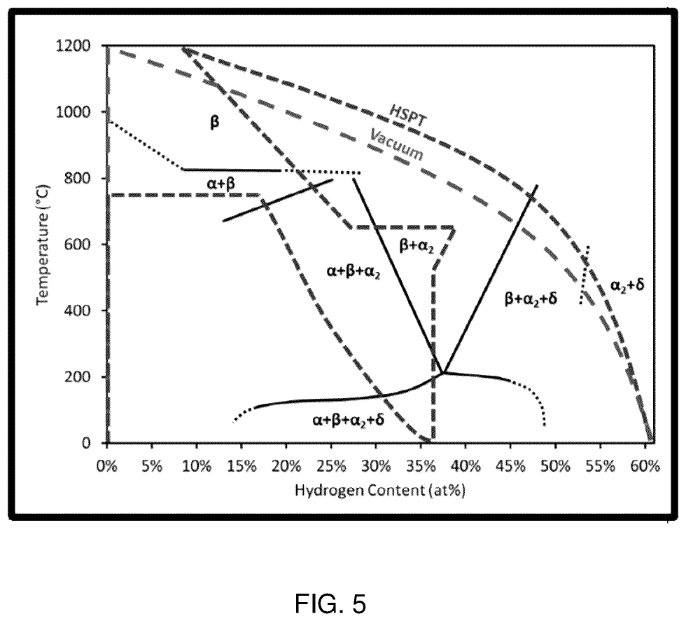

Example 1. Ten rods were formed by binder jet 3D printing. The titanium feedstock used was a Ti-6Al-4V powder mixture having an average particle size in the range of 30-40 μm. Five of the rods were sintered in an argon atmosphere as a control group. The other five rods were sintered using the HSPT process. The argon sintering process is represented by the graph in FIG. 3. The HSPT process is represented by the graph in FIG. 4. FIG. 5 also shows a phase diagram with a vacuum sintering process represented by long dashes (this is similar to an argon sintering process). On the phase diagram, the short dashed line represents the HSPT process.

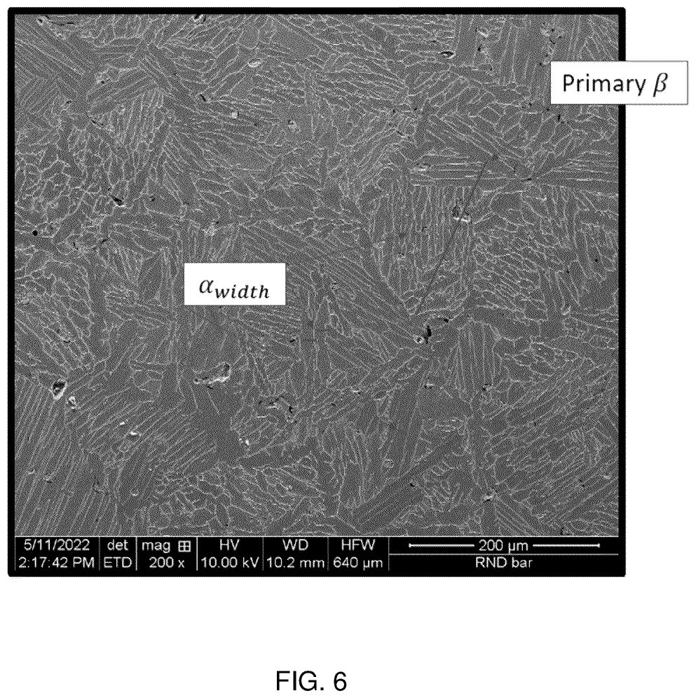

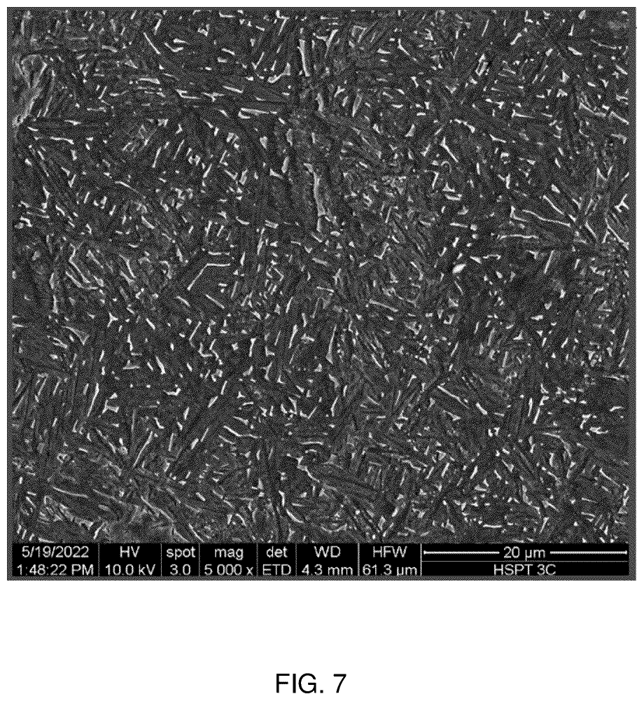

The microstructure of the sintered rods was examined using a scanning electron microscope. The argon sintered rods had an average prior p grain size of 152 μm and an average a grain width of 5 to 24 μm. The microstructure of an argon sintered rod is shown in FIG. 6. The rods that were sintered using the HSPT process had a much smaller average grain size. In the HSPT sintered rods, the α grains had a length of 3 to 8.5 μm, compared to a width of 5 to 24 μm in the argon sintered rods (the width of the grains was much smaller than the length, thus the a grains in the HSPT rods had much smaller grains than the argon sintered rods). The microstructure of an HSPT sintered rod is shown in FIG. 7 (note that the scale of FIG. 7 is 20 μm and the scale of FIG. 6 is 200 μm.

The final sintered rods had an average part density of 96.2% of the theoretical density of Ti-6Al-4V, which was about equal for the HSPT rods and the control group of argon sintered rods. The oxygen content of the rods was below 0.18 wt %. The carbon content was below 0.08 wt %. The tensile strength of the rods was then tested. The HSPT sintered rods had an average ultimate tensile strength of 1133 MPa. The argon sintered rods had an average ultimate tensile strength of 847 MPa. The ASTM standard for ultimate tensile strength of Ti-6Al-4V is 896 MPa. The elongation of the HSPT sintered rods was 11.6%. The elongation of the argon sintered rods was 13.5%. The ASTM standard for elongation is 10% or greater. Thus, the sintered rods made using the additive manufacturing process and HSPT sintering process described herein were superior to the ASTM standards for Ti-6Al-4V mechanical properties.

Example 2. Ten more Ti-6Al-4V rods were formed by binder jet printing. Five of the rods were printed with full binder applied throughout the volume of the rods. The other five rods were printed with a shell and infill, which reduced the amount of binder used by 45%. All ten rods were sintered using the HSPT process. The rods all showed a similar microstructure. The rods that were printed with shell and infill were found to be slightly denser than the rods printed with full binder. The rods with shell and infill also had a lower concentration of carbon and oxygen. The rods printed with shell and infill were also tested for mechanical properties, and they were found to surpass the ASTM standard for ultimate tensile strength.

1. A method of making a densified sintered titanium article comprising:
forming a powder bed of a titanium feedstock;
applying a binder to a portion of the powder bed to bind the titanium feedstock together, thereby forming a green body;
debinding the green body to remove at least a portion of the binder to form a debinded titanium article;
sintering the debinded titanium article at a sintering temperature in an atmosphere comprising hydrogen to produce a sintered titanium article;
holding the sintered titanium article at a phase transformation temperature to form a microstructure-controlled titanium article; and
dehydrogenating the microstructure-controlled titanium article to form a densified sintered titanium article.

2. The method of claim 1, wherein the titanium feedstock is one or more of commercially pure titanium, elemental titanium, titanium hydride titanium alloy, hydrogenated titanium alloy, and a titanium composite.

3. The method of claim 1, wherein the titanium feedstock further includes an alloying metal.

4. The method of claim 1, wherein the titanium feedstock has an average particle size from 0.1 μm to 200 μm.

5. The method of claim 1, wherein the titanium feedstock is produced by granulation-sintering-deoxygenation (GSD); hydrogen assisted magnesiothermic reduction of TiO₂ (HAMR); hydrogenation-dehydrogenation (HDH); or direct reduction and alloying (DRA).

6. The method of claim 5, wherein the titanium feedstock is produced by GSD and has a sphericity of 0.92 to 0.98 and has a surface morphology of hills and valleys not exceeding 1/10 of a particle size.

7. (canceled)

8. The method of claim 5, wherein the titanium feedstock is produced by HAMR and has a sphericity of 0.6 to 0.90 and has an oxygen content less than 0.2%.

9. (canceled)

10. (canceled)

11. (canceled)

12. The method of claim 1, wherein the binder is substantially free of silicon.

13. The method of claim 1, wherein the binder comprises 0.1% to 5% by weight of the green body.

14. The method of claim 1, wherein the binder volatilizes and leaves substantially no carbon residue in the densified sintered titanium article.

15. The method of claim 14, wherein the binder volatilizes at a temperature from about 200 to about 450° C.

16. The method of claim 1, wherein forming the powder bed comprises repeatedly depositing individual layers of unbound titanium feedstock, wherein the individual layers have a layer thickness from about 10 μm to 100 μm, and wherein applying the binder comprises repeatedly applying the binder to portions of the individual layers of unbound titanium feedstock.

17. The method of claim 16, wherein the titanium feedstock has an average particle size that is less than 40% of the layer thickness.

18. The method of claim 1, wherein the green body has a green density of 40% to 70% by volume.

19. The method of claim 1, wherein the debinding is performed by heating at a debinding temperature for a debinding time sufficient to remove greater than 97% of the binder.

20. The method of claim 19, wherein the debinding temperature is below 850° F. and the debinding time is about one hour.

21. (canceled)

22. The method of claim 18, wherein the debinding occurs under vacuum with optional backfill hydrogen or flowing inert gas with optional partial hydrogen.

23. The method of claim 1, wherein sintering occurs in a dynamically controlled hydrogen atmosphere at an elevated temperature to form the sintered titanium article containing hydrogen, wherein the dynamically controlled hydrogen atmosphere comprises primarily hydrogen that was not produced from the titanium feedstock.

24. The method of claim 23, wherein the elevated temperature is about 1000° C. to about 1500° C. and the dynamically controlled hydrogen atmosphere further includes hydrogen and an inert gas at a ratio within about 10% of a 50/50 volume ratio.

25. (canceled)

26. The method of claim 23, further comprising equilibrating the sintered titanium article at an equilibration temperature below the sintering temperature and above a phase transformation temperature for an equilibration time sufficient for the hydrogen within the article to reach equilibrium with the dynamically controlled hydrogen atmosphere and homogenize the sintered titanium article.

27. The method of claim 1, wherein the phase transformation temperature is below the sintering temperature and wherein the holding is performed for a hold time sufficient for phase transformations of the sintered titanium article to form the microstructure-controlled titanium article and wherein the phase transformation temperature is 400° C. to 900° C.

28.-39. (canceled)
